(19) United States
(12) Patent Application Publication
(10) Pub. No.: US 2015/0292557 A1
(43) Pub. Date: Oct. 15, 2015

(54) CAGE FOR ROLLING BEARING ASSEMBLY AND ROLLING ELEMENT-CAGE ASSEMBLY WITH ENHANCED LUBRICATING ABILITIES

(71) Applicant: Schaeffler Technologies AG & Co. KG, Herzogenaurach (DE)

(72) Inventor: Edward J. WEY, Waxhaw, NC (US)

(73) Assignee: Schaeffler Technologies AG & Co. KG, Herzogenaurach (DE)

(21) Appl. No.: 14/644,775

(22) Filed: Mar. 11, 2015

Related U.S. Application Data
(60) Provisional application No. 61/978,433, filed on Apr. 11, 2014.

(51) Int. Cl. F16C 33/46; F16C 33/56; F16C 33/54

(52) U.S. Cl. CPC F16C 33/4676; F16C 33/542; F16C 33/541; F16C 33/56

(57) ABSTRACT

A roller-cage assembly including a plurality of rolling elements and a cage is provided. The cage includes a first radial flange, a second radial flange, and a plurality of crossbars extending therebetween that define a plurality of rolling element pockets. The rolling elements are located in at least some of the pockets, and the plurality of crossbars each include lateral surfaces that border the plurality of rolling element pockets. Each of the lateral surfaces have a recess extending less than an axial length of each of the plurality of rolling elements along a medial portion of the crossbar. First and second axial end portions of the respective crossbars are located outside of the recesses such that each of the plurality of rolling elements is laterally supported by the first and second axial end portions of adjacent ones of the respective crossbars.

### INCORPORATION BY REFERENCE

The following documents are incorporated herein by reference as if fully set forth: U.S. Provisional Patent Application No. 61/978,433, filed Apr. 11, 2014.

### FIELD OF INVENTION

This application is generally related to a rolling bearing assembly and is more particularly related to a cage for rolling elements in a rolling bearing assembly.

### BACKGROUND

Rolling bearing assemblies are used in a wide range of automotive and various other mechanical applications. Known rolling bearing assemblies include an inner bearing ring, an outer bearing ring, a plurality of rolling elements, and a cage for guiding the plurality of rolling elements during rotation on the inner and outer rings. The inner and outer rings may be formed as separate elements and assembled with the rolling elements and the cage, or may be part of the mechanical assembly, for example with the inner ring being integral to a shaft. Lubricant is supplied in known rolling bearing assemblies in order to reduce friction and wear between the contact surfaces of the rolling elements, the cage, and the rings. In order to reduce costs, manufacturers sometimes use lower cost lubricants which include a lower content of friction reducing additives. In addition, in order to reduce parasitic drag and thus improve fuel economy, manufacturers sometimes lower the viscosity of the lubricants. It is desirable to find alternative ways to maintain an adequate film of lubricant on the contact surfaces of a bearing assembly despite using these lower cost and lower quality lubricants.

Additionally, the known cages for rolling bearing assemblies include crossbars having continuous lateral surfaces that support the rolling elements along an entire axial extent of the rolling elements and crossbar. These known crossbars physically wipe lubricant from the contact surfaces, resulting in increased friction and wear, which causes microscopic metallic particles to chip off of the contact surfaces and contaminate the lubricant. The metallic particles further degrade the friction reducing ability of the already compromised film of lubricant.

### SUMMARY

It would be desirable to provide an alternative cage configuration that reduces the amount of lubricant that the crossbars of the cage wipe from the contact surfaces of the rolling bearing elements while still providing adequate guidance for the rolling elements during rotation.

A rolling-element-cage assembly for a bearing is provided. The rolling-element-cage assembly includes a cage and a plurality of rolling elements supported in the cage. The cage includes a first radial flange, a second radial flange, and a plurality of crossbars extending therebetween that define a plurality of rolling element pockets. The plurality of crossbars each include lateral surfaces that border the plurality of rolling element pockets. Each of the lateral surfaces have a recess extending less than an axial length of the rolling elements along a medial portion of the crossbars. First and second axial end portions of the respective crossbars are located outside of the recesses such that each of the plurality of rolling elements is laterally supported by the first and second axial end portions of adjacent ones of the respective crossbars. The recesses on the lateral surface of the crossbar prevent lubricant from being wiped off of center portions of the plurality of rolling elements. This provides an improved film of lubricant on the plurality of rolling elements. The recesses also reduce the contact area with the cage, where spalling may occur which causes metallic particles to contaminate the lubricant, further reducing the ability of the lubricant to decrease friction and wear between the contact surfaces. The recesses also provide an improved flow path for the lubricant, which can help to reduce the operating temperature of the rolling-element-cage assembly in a rolling bearing arrangement during rotation.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the Drawings:

FIG. 1 is a cross-sectional view through a rolling bearing assembly according to the prior art.

FIG. 2 is a perspective view of a cage of the rolling bearing assembly according to the prior art.

FIG. 3 is a partial elevational view in a radial direction of the cage for supporting rolling elements according to the prior art.

FIG. 4 is a partial elevational view in the radial direction of a cage for supporting rolling elements in a roller-cage assembly assembly according to the present invention.

FIG. 5 is a magnified cross-sectional view in the radial direction of the cage of FIG. 4.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivates thereof, and words of similar import.

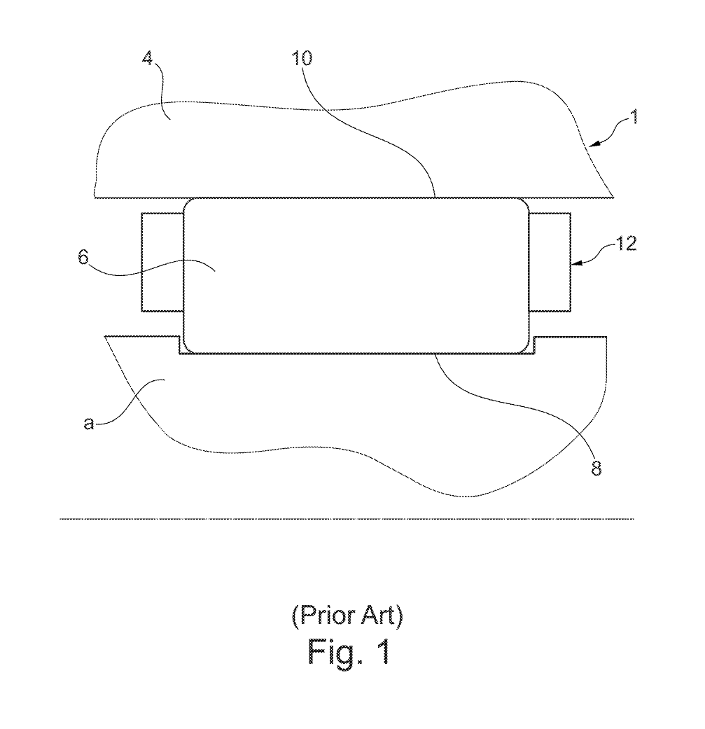

FIG. 1 shows a rolling bearing assembly 1 according to the prior art. The rolling bearing assembly 1 includes a radially inner bearing ring 2, a radially outer bearing ring 4, a plurality of rolling elements 6, and a cage 12. The plurality of rolling elements 6 are supported between the inner bearing ring 2 and the outer bearing ring 4. In one embodiment, the plurality of rolling elements 6 include an outer diameter that extends in a substantially straight line between chamfered edges at end portions of the rolling elements 6. In another embodiment, the rolling elements 6 include an outer diameter with a crown to reduce the stresses at the ends of the rolling elements 6. The inner bearing ring 2 defines a radially inner race 8 on which the plurality of rolling elements run 6, and the outer bearing ring 4 defines a radially outer race 10 on which the plurality of rolling elements 6 run. While an inner bearing ring 2 and outer bearing ring 4 are shown, it is also possible for the inner race 8 to be directly formed on a shaft and/or for the outer race 10 to be formed in a housing or other structure.

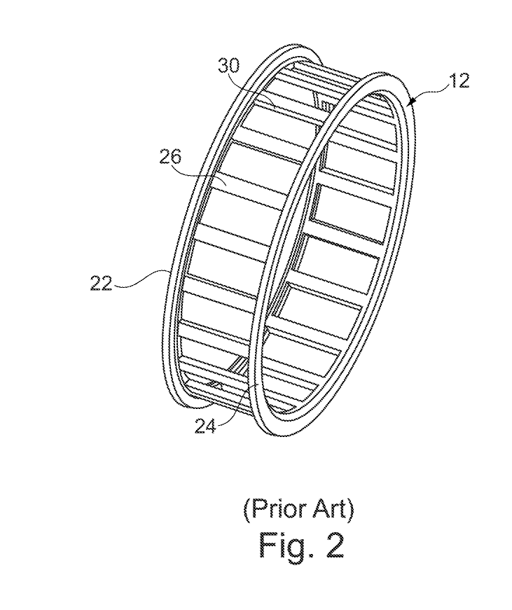

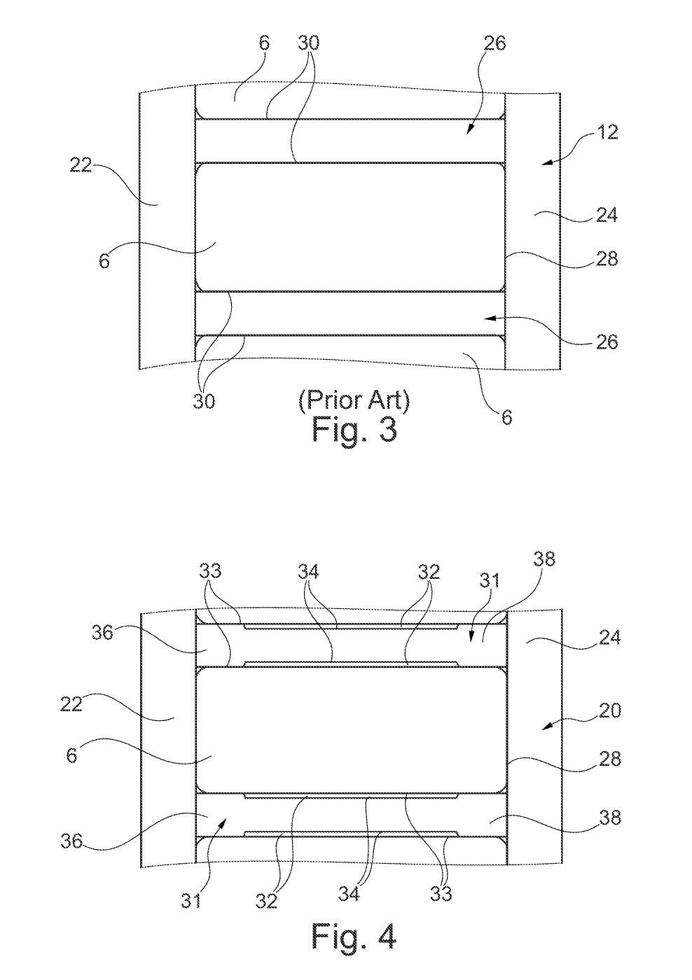

FIGS. 2 and 3 show a cage 12 according to the prior art. The cage 12 includes a first radial flange 22, a second radial flange 24, and a plurality of crossbars 26 extending therebetween that define a plurality of rolling element pockets 28. The plurality of rolling element pockets 28 provide spaces for guiding the rolling elements 6 as they run on the radially inner race 8 and the radially outer race 10. The plurality of crossbars 26 each include lateral surfaces 30 that border the plurality of rolling element pockets 28. As shown in FIG. 3, the crossbars 26 have a continuous lateral surface 30, and contact an entire axial length of the rolling elements 6. This continuous line of contact between the rolling elements 6 and the lateral surfaces 30 of the crossbars 26 reduces the film of lubricant on the contact surface. The reduced film of lubricant increases friction and wear between the contact surfaces, and causes microscopic metallic particles to chip off of the contact surfaces and contaminate the lubricant.

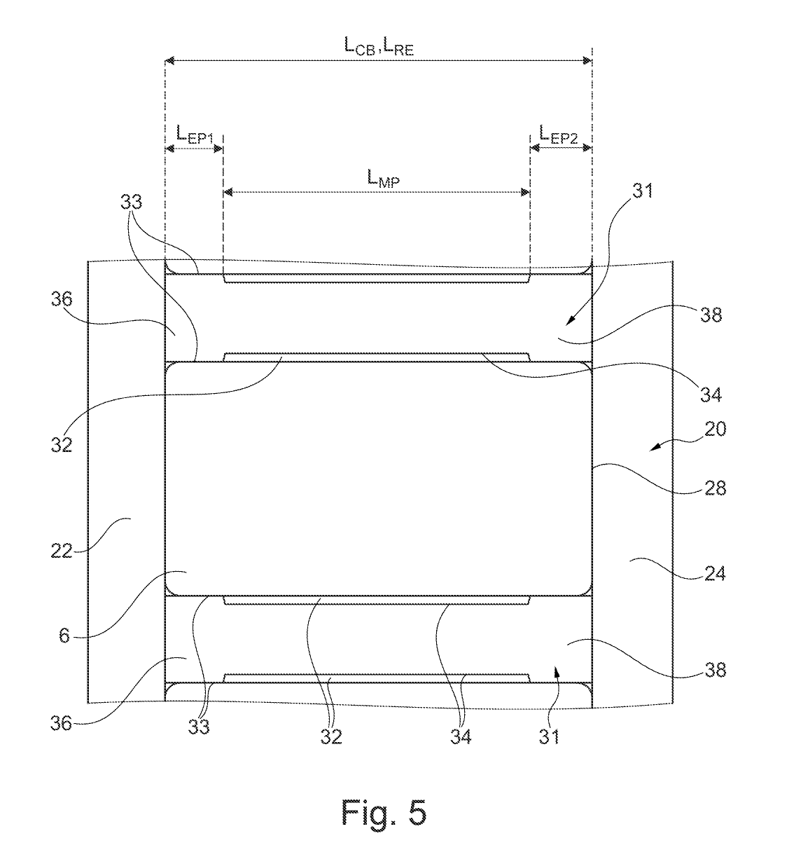

FIG. 4 shows a cage 20 according to the present invention. As shown in FIGS. 4 and 5, the crossbars 31 preferably have a generally I-shaped cross section. Each of the lateral surfaces 33 of the crossbars 31 include a recess 32 extending less than an axial length L_{RE} of the rolling elements 6 along a medial portion 34 of the crossbars 31. A first axial end portion 36 and a second axial end portion 38 are located outside of the recesses 32 such that each of the plurality of rolling elements 6 are laterally supported by the first and second axial end portions 36, 38 of adjacent ones of the respective crossbars 31. The configuration of the cage 20 prevents the crossbars 31 from wiping lubricant off of a central portion of the rolling elements 6, which helps maintain the film of lubricant on the contact surfaces. The cage 20 still provides adequate guiding support to the rolling elements 6 via the first and second axial end portions 36, 38 of the crossbars 31.

As shown in FIG. 5, the axial length of the first end portion 36 of the crossbar 31 is defined a L_{EP1}, the axial length of the second end portion 38 is defined as L_{EP2}, the axial length of the medial portion 34 is defined as L_{MP}, and the total axial length of the crossbar 31 is defined as L_{CB}. The axial length of the rolling elements 6 is defined as L_{RE}. The first and second axial end portions 36, 38 preferably extend between 20-35% of the total length L_{CB} of the crossbar 31, and more preferably extend between 25-30% of the total length L_{CB} of the crossbar 31. In a preferred configuration of the cage 20, the recess 32 extends between 30-60% of the axial length L_{RE} of each of the plurality of rolling elements 6, and more preferably extends between 40-50% of the axial length L_{RE} of each of the plurality of rolling elements 6. The above-mentioned dimensions and ratios are shown in FIG. 5, which is not drawn to scale. In one preferred configuration, the cage 20 is formed from stamped sheet metal. In another preferred configuration, the cage 20 is formed from molded polymeric material. In yet another preferred configuration, the cage 20 is formed from sintered metal.

Having thus described various embodiments of the present rolling bearing assembly in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### LIST OF REFERENCE NUMBERS

1. Rolling Bearing Assembly
2. Inner Bearing Ring
4. Outer Bearing Ring
6. Plurality of Rolling Elements
8. Radially Inner Race
10. Radially Outer Race
12. Cage
20. Cage
22. First Radial Flange of Cage
24. Second Radial Flange of Cage
26. Crossbar
28. Rolling Element Pockets
30. Lateral Surfaces of Crossbar
31. Crossbar
32. Recess
33. Lateral Surfaces of Crossbar
34. Medial Portion of Crossbar
36. First Axial End Portion of Crossbar
38. Second Axial End Portion of Crossbar
L_{RE}—Axial Length of Rolling Element
L_{CB}—Total Axial Length of Crossbar
L_{MP}—Axial Length of Medial Portion of Crossbar
L_{EP1}—Axial Length of First Axial End Portion of Crossbar
L_{EP2}—Axial Length of Second Axial End Portion of Crossbar

What is claimed is:

1. A roller-cage assembly comprising:
a plurality of rolling elements; and
a cage including a first radial flange, a second radial flange, and a plurality of crossbars extending therebetween that define a plurality of rolling element pockets, the rolling elements being located in at least some of the pockets, the plurality of crossbars each include lateral surfaces that border the plurality of rolling element pockets, each of the lateral surfaces having a recess extending less than an axial length of each of the plurality of rolling elements along a medial portion of the crossbar, and first and second axial end portions of the respective crossbars are located outside of the recesses such that each of the plurality of rolling elements is laterally supported by the first and second axial end portions of adjacent ones of the respective crossbars.

2. The roller-cage assembly of claim 1, wherein the first and second axial end portions extend between 25-30% of a total length of the crossbar.

3. The roller-cage assembly of claim 1, wherein the recesses extend between 40-50% of the axial length of each of the plurality of rolling elements.

4. The roller-cage assembly of claim 1, wherein the plurality of rolling elements are cylindrical rollers.

5. The roller-cage assembly of claim 1, wherein the crossbars have a generally I-shaped cross section.

6. The roller-cage assembly of claim 1, wherein the cage is formed from stamped sheet metal.

7. The roller-cage assembly of claim 1, wherein the cage is formed from molded polymeric material.

8. The roller-cage assembly of claim 1, wherein the cage is formed from sintered metal.

9. A rolling bearing assembly, comprising an inner ring, an outer ring, and the roller-cage assembly of claim 1.

10. A rolling bearing assembly comprising:
an inner bearing ring;
an outer bearing ring;
a plurality of rolling elements supported between the inner bearing ring and the outer bearing ring, the inner bearing ring defines a radially inner race on which the plurality of rolling elements run, and the outer bearing ring defines a radially outer race on which the plurality of rolling elements run; and
a cage including a first radial flange, a second radial flange, and a plurality of crossbars extending therebetween that define a plurality of rolling element pockets, the rolling elements being located in at least some of the pockets, the plurality of crossbars each include lateral surfaces that border the plurality of rolling element pockets, each of the lateral surfaces having a recess extending less than an axial length of each of the plurality of rolling elements along a medial portion of the crossbar, and first and second axial end portions of the respective crossbars are located outside of the recesses such that each of the plurality of rolling elements is laterally supported by the first and second axial end portions of adjacent ones of the respective crossbars.
